(19) United States
(12) Patent Application Publication
(10) Pub. No.: US 2023/0394717 A1
(43) Pub. Date: Dec. 7, 2023

(54) System and Method for Improved Artefact Correction in Reconstructed 2D/3D Images

(71) Applicant: GE Precision Healthcare LLC, Wauwatosa, WI (US)

(72) Inventors: Vincent Bismuth, Paris (FR); Sylvain Bernard, Montigny-le-Bretonneux (FR); Giang-Chau Ngo, Viroflay (FR); Charlotte Delmas, Paris (FR); Solène Coeuret, Paris (FR)

(21) Appl. No.: 18/233,649

(22) Filed: Aug. 14, 2023

Related U.S. Application Data
(63) Continuation-in-part of application No. 17/667,764, filed on Feb. 9, 2022.

(51) Int. Cl. G06T 11/00; G06T 15/20; G06T 7/00

(52) U.S. Cl. CPC G06T 11/008; G06T 15/205; G06T 2207/30068; G06T 2207/10081; G06T 2207/10088; G06T 7/0012

(57) ABSTRACT

An image processing system and method is provided for correcting artefacts within a three-dimensional (3D) volume reconstructed from a plurality of two-dimensional (2D) projection images of an object. The system and method is implemented on an imaging system having a processing unit operable to control the operation of a radiation source and a detector to generate a plurality of 2D projection images. The system also includes a memory connected to the processing unit and storing processor-executable code that when executed by the processing unit operates to reconstruct the 3D volume from the plurality of 2D projection images, the 3D volume defined in a pseudo parallel geometry based on a zero angle from the plurality of 2D projection images, wherein reconstructing the 3D volume comprises reconstructing a 3D virtual object defined in a pseudo parallel geometry based on the zero angle from the plurality of 2D projection images, and correcting the 3D virtual object to form the 3D volume.

### CROSS-REFERENCE TO RELATED APPLICATIONS

This application claims priority as a continuation-in-part of U.S. application Ser. No. 17/667,764, entitled Fast And Low Memory Usage Convolutional Neural Network For Tomosynthesis Data Processing And Feature Detection and filed on Feb. 9, 2022, the entirety of which is expressly incorporated herein by reference for all purposes.

### FIELD OF THE DISCLOSURE

The subject matter disclosed herein relates generally to image reconstruction, and, more particularly, to systems and methods for deep learning-based image reconstruction.

### BACKGROUND OF THE DISCLOSURE

Radiography is generally used for seeking abnormalities in an object of interest. A radiography image represents a projection of an object, for example an organ of a patient. In a more specific, non-limiting, example, the organ is a breast and the images are mammographic images. Mammography has been used for decades for screening and diagnosing breast cancer. The radiography image is generally obtained by placing the object between a source emitting X-rays and a detector of X-rays, so that the X-rays attain the detector having crossed the object. The radiography image is then constructed from data provided by the detector and represents the object projected on the detector in the direction of the X-rays.

In the case of mammography, an experienced radiologist may distinguish radiological signs indicating a potential problem, for example microcalcification, masses, or other opacities. However, in a two-dimensional (2D) projection image, superposition of the tissues may hide lesions, and in no case is their actual position known in the object of interest, the practitioner not having any information on the depth of the radiological sign in the projection direction.

Tomosynthesis is used in order to address these problems. In tomosynthesis, a three-dimensional (3D) representation of an organ may be obtained as a series of successive slices. The slices are reconstructed from projections of the object of interest under various angles. To do this, the object of interest is generally placed between a source emitting X-rays and a detector of X-rays, as schematically illustrated in FIGS. 1 and 2. The source and/or the detector are mobile, so that the direction of projection of the object on the detector may vary (e.g., over an angular range of 30 degrees, etc.). Several projections of the object of interest are thereby obtained under different angles, from which a three-dimensional representation of the object may be reconstructed, generally by a reconstruction method, for example. For the determination and/or identification of the various views of the object, a coordinate system 2000 is defined by the imaging system 2001, such that the various views of the imaged object can be selected along one or more of the XY plane 2002, XZ plane 2004 or YZ plane 2006, as defined by the coordinate system 2000, e.g., where the XY planes are all planes parallel to the XY plane, (same for XZ, YZ).

While both standard mammography and tomosynthesis are currently used by radiologists, each technique has advantages. Standard mammography may form better images than tomosynthesis in imaging microcalcifications. Tomosynthesis is superior in imaging soft tissue lesions, for instance spiculated masses as the reconstruction in the tomosynthesis mostly clears out the tissues above and below the lesion and enables its localization within the organ.

While radiologists may acquire both standard mammography and tomosynthesis images to leverage the advantages of each technique, these imaging processes are typically performed sequentially.

In recent years, digital breast tomosynthesis (DBT) has proved to be effective cancer detection techniques and CE-DBT techniques are under development. DBT and/or CE-DBT creates a three-dimensional (3D) image of the breast using x-rays. By taking multiple x-ray pictures of each breast from many angles, a computer can generate a 3D image used to detect abnormalities. A critical part of the DBT/CE-DBT process is image reconstruction as it directly impacts the content of the data that the radiologists will review to determine any diagnosis. To reconstruct the image, algorithms are designed, trained (if applicable for algorithm employed with an artificial intelligence (AI) as a component thereof) and used to reduce the noise and minimize any artefact, e.g., streaks, limited angle artefacts, over and undershoots, etc., present in a reconstructed volume. These algorithms can take a variety of forms. Over the past years these algorithms most often tend to include one or several convolutional neural networks (CNN) as components thereof, with particular examples being one or more of: FBP ConvNET disclosed in: Jin, Kyong Hwan, et al. “Deep convolutional neural network for inverse problems in imaging.” IEEE Transactions on image Processing 26.9 (2017): 4509-4522., unrolled reconstruction as disclosed in Wang, Ge, Jong Chul Ye, and Bruno De Man. “Deep learning for tomographic image reconstruction.” Nature Machine Intelligence 2.12 (2020): 737-748. or learned primal dual reconstructions disclosed in Jonas Teuwen, Nikita Moriakov, Christian Fedon, Marco Caballo, Ingrid Reiser, Pedrag Bakic, Eloy García, Oliver Diaz, Koen Michielsen, Ioannis Sechopoulos, “Deep learning reconstruction of digital breast tomosynthesis images for accurate breast density and patient-specific radiation dose estimation”, Medical Image Analysis, Volume 71, 2021, 102061, ISSN 1361-8415, the entirety of which are each expressly incorporated herein by reference for all purposes. The algorithm can contain CNNs in the projection domain and/or CNNs in the volume domain. In the volume domain, the CNN can process each plane separately (i.e., a 2D CNN), each plane with some context of or from the neighboring planes (i.e., a 2.5D CNN) or use 3D CNN (using local 3D neighborhoods and 3D features). In tomosynthesis, and in particular DBT/CE-DBT, the CNN can be used to overcome/remove the artefacts coming from the constrained acquisition geometry present within DBT, i.e., the limited angular range over which projections are obtained, i.e., typically from 15 to 50 degrees of angular coverage and/or the sparse angular sampling, i.e., typically 9 to 25 projections obtained over the defined angular range. Artefacts around a given object in the volume tend to align locally with the back-projection lines intersecting at this object, and are thus very dependent on the acquisition geometry. With typical beam geometries as schematically represented in FIG. 3, the orientation of the artefacts is location dependent in the 3D space. When an imaging system operated to perform DBT by emitting a cone beam from a source towards a detector, close to the patient chest wall, artefacts are mostly contained in the XZ planes but their orientation depends on the location/depth within this plane. As we move away from the chestwall along the y-axis, the artefacts tend to align with slanted planes defined by the beam path(s) within the cone beam between the source and the detector. With particular reference to FIG. 3, for example, an artefact at location p₁ is located close to a chest wall approximately parallel to the XZ plane. However, artefact at location p₂ is disposed at significant angular orientation relative to the XZ plane. At a further artefact at location p₃, the artefacts are rotated compared to their orientation at p₁, but they are in the same XZ plane.

To correct the artefacts at locations p₁ p₂ and p₃, a reconstruction algorithm that contains networks (e.g., CNNs) to reduce artefacts must be trained with artefacts of all possible appearance and orientations to be able to accommodate for the angular positions of the artefacts with respect to changes in orientation, and must also be tested against the variability in artefact appearance. Moreover, while a simple 2D CNN operating in the XZ planes could correct efficiently artefacts close to the chest wall where they are totally contained in these XZ planes, e.g. at point p₁, but the 2D trained CNN would not be as efficient at correction of artefacts further from the XZ plane e.g., at point p₂. This means that some CNN designs cannot be used efficiently for correction of artefacts in DBT projections, especially some 2D and 2.5D CNNs.

In contrast, for computed tomography, which employs a fan beam emitted from the radiation source, the reconstruction artefacts arising from limited angle and sparse sampling that impair a given structure tend to be almost perfectly located in the reconstruction planes and appear similar in every plane as a result of the narrow planes imaged by the fan beam. This enables simpler training and testing process for the algorithms and deep learning networks, e.g., CNNs, as well as processing the artefacts with 2D CNN.

Because of the issues regarding the requirement to accommodate the orientation changes of artefacts relative to the coordinate axes, it is not convenient to design, train and test these CNNs for use in DBT. The need to geometrically address the position and appearance of the artefacts in the slanted planes during the reconstruction process complicates the form, training and testing of CNNs needed to ensure proper sampling of the artefact orientation for all geometries (e.g., 2D, 2.5D and 3D) in both training and testing requires significant additional computational capability and consequent complexity of the CNNs in order to accommodate these orientation changes. The omission of these adjustments during design, training and testing also limits the ability to use a CNN trained on CT data or CT-like geometries to adapt them to use in DBT.

In order to assist in creating more accurate volumes and improve artefact correction within the reconstruction of 2D and 3D images, certain systems and methods have been developed, such as that disclosed in U.S. Pat. No. 11,227,418 (the '418 Patent), entitled Systems And Methods For Deep Learning-Based Image Reconstruction, the entirety of which is expressly incorporated herein by reference for all purposes. In this system and method, the system obtains a plurality of two-dimensional (2D) tomosynthesis projection images of an organ by rotating an x-ray emitter to a plurality of orientations relative to the organ and emitting a first level of x-ray energization from the emitter for each projection image of the plurality of 2D tomosynthesis projection images, reconstructs a three-dimensional (3D) volume of the organ from the plurality of 2D tomosynthesis projection images, obtains an x-ray image of the organ with a second level of x-ray energization, generates a synthetic 2D image generation algorithm from the reconstructed 3D volume based on a similarity metric between the synthetic 2D image and the x-ray image, and deploys a model instantiating the synthetic 2D image generation algorithm.

Further, PCT Patent Application Publication No. WO2021/155123A1 (the '123 application), entitled Systems And Methods For Artifact Reduction In Tomosynthesis With Deep Learning Image Processing, the entirety of which is expressly incorporated herein by reference for all purposes, also provides an alternative to this issue that relies on a tomosynthesis acquisition dataset and processes it with a very specific kind of deep learning based reconstruction to reduce the artefacts, using a standard single energy acquisition. While the system and methods of the '418 patent and of the '123 application enhance the reconstruction of the 3D volume in comparison with prior reconstruction systems and processes, the disclosures of the '418 patent and the '123 application still require the utilization of a complex deep learning algorithm trained to attenuate and/or remove artefacts in a manner that employs the natural geometry of the object to be reconstructed using the known conic X-ray beam shape to perform the operations of backprojection and forward projection. In this case the artefact orientation is dependent on the X, Y, Z position of the voxel.

A side effect of this standard way to operate the imaging system, which can be a radiography or mammography imaging system—which is denoted “conic geometry” in this application—employed in other image reconstruction processes, such as those utilized in the '418 patent and the '123 application, is that the artefacts due to the geometry of the acquisition sequence and beam are significantly varying with the spatial location in the volume, i.e., non-translation invariance, as described previously. As a result, many artefacts are not aligned with the reconstruction coordinate axes and planes shown in FIG. 3, i.e., they tend to locally align with slanted planes or even curved surfaces. This significantly complicates the sampling of the training and the test coverage of a deep learning algorithm, e.g., a 2D, 2.5D or 3D CNN network, in order to accommodate the requirement for accommodating the non-translation invariance of the artefacts. It also impairs the straightforward use of 2D or 2.5D networks that can readily be employed in reconstructions of the object along the XZ planes, since the artefacts are not contained in this plane, as well as any potential adaptation of CT-like approaches.

As a result, it is desirable to develop an improved system and method for image reconstruction which simplifies the beam geometries utilized in the both the training and operation of the deep learning algorithm, e.g., CNN, to improve the processing speed and performance of the deep learning algorithms, and to combine this simplified geometry with proper CNN design and training strategy. In particular, it is desirable to develop a system and method, e.g., a CNN, that provides a correction for artefacts in a manner where it would not be necessary to account with the non-translation invariance of the artefact in the training and testing phases. It is also is desirable to develop a system and method, e.g., a CNN, that provides a correction for artefacts in the XZ planes of a 3D volume in a manner employing a geometric correction to allow the CNN to be constructed as a 2D CNN trained with a 2D image database to alleviate the database construction task.

### SUMMARY OF THE DISCLOSURE

According to one aspect of an exemplary embodiment of the disclosure, a method for correcting artefacts within a three-dimensional (3D) volume reconstructed from a plurality of two-dimensional (2D) projection images of an object includes the steps of providing an imaging system having a radiation source, a detector positionable to receive radiation emitted from the radiation source and passing through an object positioned between the source and the detector, a display for presenting information to a user, a processing unit connected to the display and operable to control the operation of the radiation source and detector to generate a plurality of 2D projection images of the object, and a memory operably connected to the processing unit and storing processor-executable code for a reconstruction algorithm that when executed by the processing unit is operable to reconstruct a three-dimensional (3D) volume of the organ from the plurality of 2D projection images, obtaining the plurality of 2D projection images, selecting a zero angle from a range of angles over which the plurality of 2D projection images are obtained, reconstructing the 3D volume from the plurality of 2D projection images, the 3D volume defined in a pseudo parallel geometry based on the zero angle from the plurality of 2D projection images.

According to still another aspect of an exemplary embodiment of the present disclosure, an imaging system includes a radiation source, a detector positionable to receive radiation emitted from the radiation source and passing through an object positioned between the source and the detector, a display for presenting information to a user, a processing unit connected to the display and operable to control the operation of the radiation source and detector to generate a plurality of 2D projection images of the object, and a memory operably connected to the processing unit and storing processor-executable code for a reconstruction algorithm that when executed by the processing unit is operable to reconstruct a three-dimensional (3D) volume of the organ from the plurality of 2D projection images, wherein the memory includes processor-executable code for reconstructing the 3D volume from the plurality of 2D projection images, the 3D volume defined in a pseudo parallel geometry based on a zero angle from the plurality of 2D projection images, wherein the step of reconstructing the 3D volume comprises reconstructing a 3D virtual object defined in a pseudo parallel geometry based on the zero angle from the plurality of 2D projection images; and correcting the 3D virtual object to form the 3D volume.

These and other exemplary aspects, features and advantages of the invention will be made apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is a schematic diagram of an imaging device employed for radiographic image reconstruction and associated coordinate system represented thereon.

FIG. 2 is a schematic view of the imaging system of FIG. 1 and associated coordinate planes defined by the coordinate system.

FIG. 3 is a schematic diagram of an example geometry for correction of artefacts for reconstruction of an object in planes along the XZ axis.

FIG. 4 is a schematic view of a radiography imaging system employing the improved pseudo parallel geometry reconstruction and correction processing system according to one exemplary embodiment of the present disclosure.

FIG. 5 is a schematic view of the manner of movement of the imaging system of FIG. 4.

FIGS. 6A-6B are schematic views of the form of a virtual object prior to and after application of the pseudo parallel geometry reconstruction and correction processing system according to an embodiment of the present disclosure.

FIG. 7 is a schematic view of a first embodiment of training process for a the pseudo parallel geometry reconstruction and correction processing system according to an embodiment of the present disclosure.

FIG. 8 is a schematic view of a second embodiment of training process for the pseudo parallel geometry reconstruction and correction processing system according to an embodiment of the present disclosure.

FIG. 9 is a schematic view of a first embodiment of a method of operation of the pseudo parallel geometry reconstruction and correction processing system according to an embodiment of the present disclosure.

FIG. 10 is a schematic view of a second embodiment of a method of operation of the pseudo parallel geometry reconstruction and correction processing system according to an embodiment of the present disclosure.

FIG. 11 is a schematic view of the architecture of a first particular exemplary embodiment of a convolutional neural network employed as part of the pseudo parallel geometry reconstruction and correction processing system of FIG. 9 or 10 according to an exemplary embodiment of the disclosure.

FIG. 12 is a schematic view of a third embodiment of a method of operation of the pseudo parallel geometry reconstruction and correction processing system according to an embodiment of the present disclosure.

FIG. 13 is a schematic view of the architecture of a second particular exemplary embodiment of a primal dual reconstruction network employed as part of the pseudo parallel geometry reconstruction and correction processing system of FIG. 12 according to an exemplary embodiment of the disclosure.

FIG. 14 is a processor diagram which can be used to implement the method of FIG. 9 or 10 according to an exemplary embodiment of the disclosure.

FIG. 15 is a schematic diagram of an exemplary tomographic system according to an exemplary embodiment of the disclosure.

FIG. 16 is a schematic diagram of an exemplary tomographic system according to an exemplary embodiment of the disclosure.

### DETAILED DESCRIPTION OF THE DRAWINGS

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore, provided to describe an exemplary implementation and not to be taken limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As used herein, the terms “system,” “unit,” “module,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules, units, engines, and/or systems shown in the attached figures may represent the hardware that operates based on software or hard-wired instructions, the software that directs hardware to perform the operations, or a combination thereof.

As used herein, the term “projection” or “projection image” indicates an image obtained from emission of x-rays from a particular angle or view. A projection can be thought of as a particular example of mapping in which a set of projection images are captured from different angles of a 3D object. A reconstruction algorithm may then map or combine/fuse them to reconstruct a volume and/or create a synthetic 2D image. Each projection image is typically captured relative to a central projection (e.g. base projection, straight-on projection, zero angle projection, etc.). The resulting image from the projections is either a 3D reconstructed image that is approximately identical to the original 3D object or a synthetic 2D image that combines each projection together and benefits from the information in each view and may rely on a form of 3D reconstruction.

As used herein, the term “acquisition geometry” is a particular series of positions of an x-ray source and/or of a detector with respect to a 3D object (e.g., the breast) to obtain a series of 2D projections.

As used herein, the term “central projection” is the projection within the series of 2D projections that is obtained at or closest to the zero-orientation of the x-ray source relative to the detector, i.e., where the x-ray source is approximately orthogonal to the detector.

As used herein, the term “reference angle” is the angle at which the x-ray source is positioned relative to the detector for the central projection and from which the angular positions for each additional projection obtained within the series of 2D projections are calculated across the entire acquisition geometry.

While certain examples are described below in the context of medical or healthcare workplaces, other examples can be implemented outside the medical environment.

In many different applications, deep learning techniques have utilized learning methods that allow a machine to be given raw data and determine the representations needed for data classification or data restauration. Deep learning ascertains structure in data sets using back propagation algorithms which are used to alter internal parameters (e.g., node weights) of the deep learning machine. Deep learning machines can utilize a variety of multilayer architectures and algorithms. While machine learning, for example, involves an identification of features to be used in training the network, deep learning processes raw data to identify features of interest without the external identification.

Deep learning in a neural network environment includes numerous interconnected nodes referred to as neurons. Input neurons, activated from an outside source, activate other neurons based on connections to those other neurons which are governed by the machine parameters. A neural network behaves in a certain manner based on its own parameters. Learning refines the machine parameters, and, by extension, the connections between neurons in the network, such that the neural network behaves in a desired manner.

Deep learning operates on the understanding that many datasets include high level features which include low level features. While examining an image, for example, rather than looking for an object, it is more efficient to look for edges which form motifs which form parts, which form the object being sought. These hierarchies of features can be found in many different forms of data such as speech and text, etc.

Deep learning has been applied to inverse problems in imaging in order to improve image quality such as denoising, deblurring or to generate the desired images such as in super-resolution or 3D reconstruction. The same deep learning principles apply but instead of delivering a label (as for a classification task) the network delivers processed images. Such networks are for instance the UNet architecture.

An example use of deep learning techniques in the medical field is in radiography systems. Radiography and in particular mammography are used to screen for breast cancer and other abnormalities. Traditionally, mammograms have been formed on x-ray film. However, more recently, flat panel digital imagers have been introduced that acquire a radiographic image or mammogram in digital form, and thereby facilitate analysis and storage of the acquired images. Further, substantial attention and technological development have been dedicated toward obtaining three-dimensional images of the breast. Three-dimensional (3D) mammography is also referred to as digital breast tomosynthesis (DBT). Two-dimensional (2D) mammography is full-field digital mammography, and synthetic 2D mammography produces 2D pictures derived from 3D data by combining individual enhanced slices (e.g., 1 mm, 2 mm, etc.) of a DBT volume and/or original projections. Breast tomosynthesis systems reconstruct a 3D image volume from a series of two-dimensional (2D) projection images, each projection image obtained at a different angular displacement of an x-ray source. The reconstructed 3D image volume is typically presented as a plurality of slices of image data, the slices being geometrically reconstructed on planes parallel to the imaging detector in a reference position.

A deep learning machine can learn the neuron weights for a task in a fully supervised manner provided a dataset of inputs and outputs. For example, in one embodiment the inputs can be volumes reconstructed with the artefact(s) and outputs can be volumes without artefact(s), such as when a deep learning network such as FBPConvnet is employed. In other embodiments, inputs can be the projections themselves and the outputs are the volumes without artefacts, such as when employing a learned primal dual reconstruction. It is also possible to train a deep learning network in a semi-supervised or non-supervised manner.

Once a desired neural network behavior has been achieved (e.g., a machine has been trained to operate according to a specified performance, etc.), the machine can be deployed for use (e.g., testing the machine with “real” data, etc.). During operation, neural network outputs can be confirmed or denied (e.g., by an expert user, expert system, reference database, etc.) to continue to improve neural network behavior. Thus, parameters that determine neural network behavior can be updated based on ongoing interactions.

### Example Systems and Associated Methods

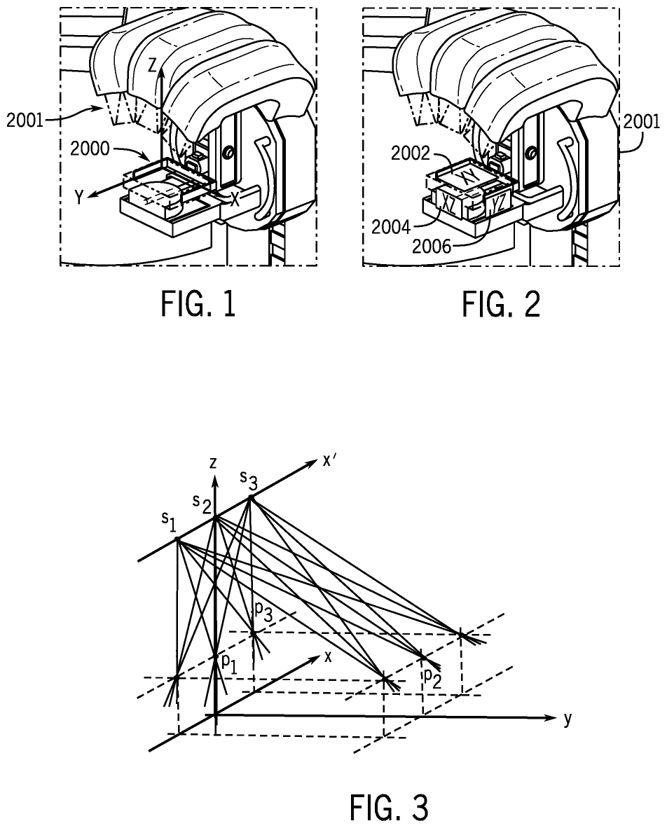

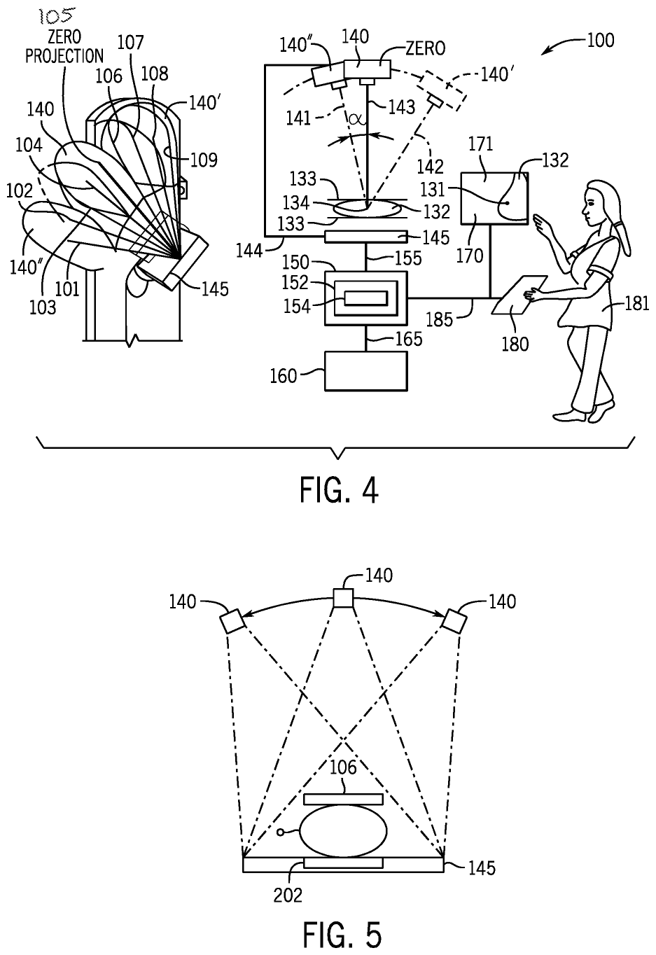

FIG. 4 illustrates an example radiography imaging system, such as a mammography imaging system 100, for obtaining one or more images of an object of interest, such as that disclosed in U.S. Pat. No. 11,227,418 (the '418 Patent), entitled Systems And Methods For Deep Learning-Based Image Reconstruction, the entirety of which is expressly incorporated herein by reference for all purposes. The example system 100 includes a radiation source, such as an x-ray beam source 140 facing the detector 145. The x-ray beam source or emitter 140 and the detector 145 are connected by an arm 144. An object of interest 132 can be placed between the detector 145 and the source 140. In the example of FIG. 1, the x-ray source 140 moves in an arc above a single detector 145. The detector 145 and a plurality of positions of the x-ray source 140′ and 140″ following an arc (see dashed line) are shown with dashed/solid lines and in a perspective partial view. In the arrangement shown in the example of FIG. 5, the detector 145 is fixed at the shown position and only the x-ray source 140 moves. The angle alpha is a projection angle enclosed by the zero-orientation, i.e., the orientation of where the x-ray source 140 is approximately orthogonal to the detector 145, and any other orientation such as 141 and 142. Using this configuration, multiple views of the breast (e.g., the object of interest 132) tissue can be acquired via the at least one x-ray source 140.

Still referring to FIG. 4, on the left side is shown a partial perspective view of the imaging system 100 including the detector 145 and the x-ray source 140. The different positions of the x-ray source 140, 140′ and 140″ are broadly depicted to illustrate the movement of the x-ray source 140. There are nine different projection views 101, 102, 102, 103, 104, 106, 107, 108, 109 including the zero or central projection 105 indicated as straight lines, taken over a range of angles which all point to the center of the detector 145. Alternatively, in certain exemplary embodiments the radiography imaging system 100 can be formed as a cone beam computed tomography (CBCT) system.

The range of angles over which the set of 2D projection images are obtained can be predetermined for a given imaging procedure, or can be set by the user via user interface 180, as well as the angular spacing of the individual 2D projection images across the range of angles between the first projection image and the last projection image. The 2D projection image closest to the zero-orientation, or orientation where the source 140 is approximately orthogonal to the detector 145 is named the central projection or zero projection by approximation. However, for the purposes of the present disclosure, the zero orientation or zero angle can be defined as the angle at which the zero projection is obtained, or as another angle within the range of angles over which the 2D projection images are obtained that is selected by the user via user interface 180 or the set by the system 100 and is orthogonal to the detector 145, such as the angle of the plane XZ, as shown in FIG. 3.

The object of interest 132 shown in display unit 170 is a breast compressed by a compression paddle 133 and cover (not shown) disposed on the detector 145, which help ensure uniform compression and immobilization of the breast during the radiation exposure for optimal image quality. The breast 132 includes, for example, a punctual object 131 as a calcification, which is located in the zero orientation 143, which is perpendicular to the detector 145 plane. The user may review calcifications or other clinical relevant structures for diagnosis, for example.

The detector 145 and the x-ray source 140 form an acquisition unit, which is connected via a data acquisition line 155 to a processing unit 150. The processing unit 150 includes a memory unit 160, which may be connected via an archive line 165, for example.

A user such as a health professional may input control signals via a user interface 180. Such signals are transferred from the user interface 180 to the processing unit 150 via the signal line 185. Using the example system 100, an enhanced 2D projection image can be obtained that appears to be a 2D mammogram. Based on this high-quality image, a radiologist and/or other user can identify clinical signs relevant for breast screening. Further, prior, stored 2D mammograms can be displayed for comparison with the new 2D projection image acquired through tomosynthesis. Tomosynthesis images may be reviewed and archived, and a CAD system, a user, etc., can provide 3D marks. A height map of punctual objects or other objects obtained from image data can be combined with height information provided based on 3D marks by a CAD system, indicated by a user through a 3D review, etc. Further, the user may decide to archive 2D full-volume images and/or other images are archived. Alternatively, or in addition, saving and storing of the images may be done automatically.

In certain examples, the memory unit 160 can be integrated with and/or separate from or remote from the processing unit 150. The memory unit 160 allows storage of data such as the 2D enhanced projection image and/or tomosynthesis 3D images. In general, the memory unit 160 can include a computer-readable medium, such as a hard disk or a CD-ROM, diskette, a ROM/RAM memory, DVD, a digital source, such as a network or the Internet, etc. The processing unit 150 is configured to execute program instructions stored in the memory unit 160, which cause the computer to perform methods and/or implement systems disclosed and described herein. One technical effect of performing the method(s) and/or implementing the system(s) is that the x-ray source may be less used, since the enhanced 2D projection image can replace a known 2D mammogram, which is usually obtained using additional x-ray exposures to get high quality images.

As the emitter 140 is rotated about the organ, the emitter 140 may further include beam shaping (not depicted) to direct the X-rays through the organ to the detector 145. The emitter 140 can be rotatable about the organ 132 to a plurality of orientations with respect to the organ 132, for example. In an example, the emitter 140 may rotate through a total arc of 30 degrees relative to the organ 132 or may rotate 30 degrees in each direction (clockwise and counterclockwise) relative to the organ 132. It will be recognized that these arcs of rotation are merely examples and not intended to be limiting on the scope of the angulation which may be used.

It will be recognized that the emitter 140 is positionable to a position or orthogonal to one or both of the organ 132 and the detector 145. In this orthogonal or center position, in one exemplary mode of operation of the system 100, a full field digital mammography (FFDM) may be acquired, particularly in an example configuration in which a single emitter 140 and detector 145 are used to acquire both the FFDM image as well as digital breast tomosynthesis (DBT) projection images. An FFDM image, also referred to as a digital mammography image, allows a full field of an object (e.g., a breast, etc.) to be imaged, rather than a small field of view (FOV) within the object. The digital detector 145 allows full-field imaging of the target object or organ 132, rather than necessitating movement and combination of multiple images representing portions of the organ 132.

The DBT projection images are acquired at various angles of the emitter 140 about the organ 132. Various imaging work flows can be implemented using the example system 100. In one example, the FFDM image, if it is obtained, is obtained at the position orthogonal to the organ, and the DBT projection images are acquired at various angles relative to the organ 132, including a DBT projection image acquired at an emitter 140 position orthogonal to the organ 132. During reconstruction, the DBT projection images are used to reconstruct the 3D volume of the organ, for example. In one exemplary embodiment, the DBT volume is reconstructed from the acquired DBT projection images, and/or the system 100 can acquire both the DBT projection images and a FFDM, and just reconstruct DBT volume from the DBT projection images.

Thus, a variety of different examples of the manner of operation of the system 100, an organ and/or other object of interest 132 can be imaged by obtaining a plurality of 2D tomosynthesis projection images of the organ 132 by rotating an x-ray emitter 140 to a plurality of orientations relative to the organ 132 and emitting x-ray energization from the emitter 140 for each projection image of the plurality of projection images, as shown in FIGS. 4 and 5. A 3D volume 171 of the organ 132 is then reconstructed from the plurality of tomosynthesis projection images 101-109 which can be used for presentation directly on the display 170 and/or for the generation of selected 2D views of portions of the 3D volume 171.

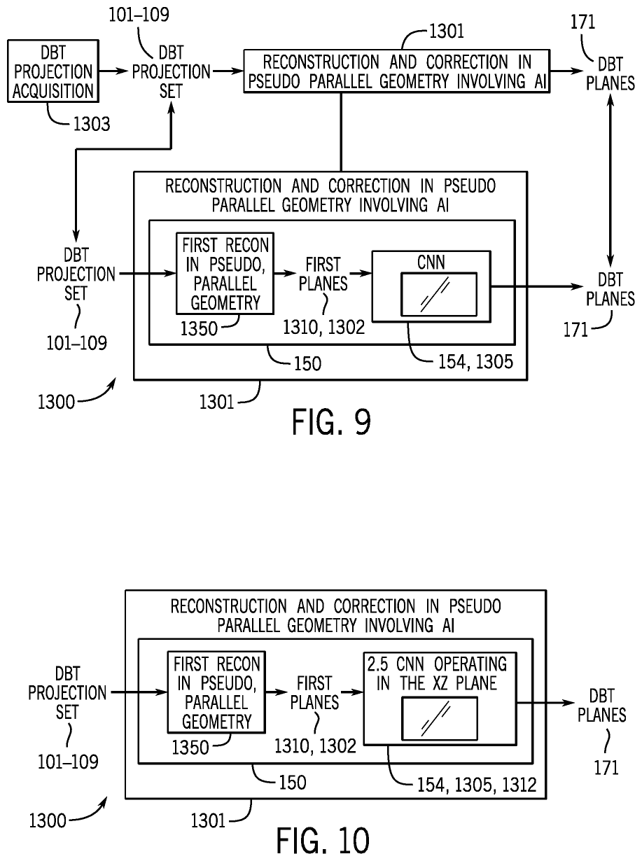

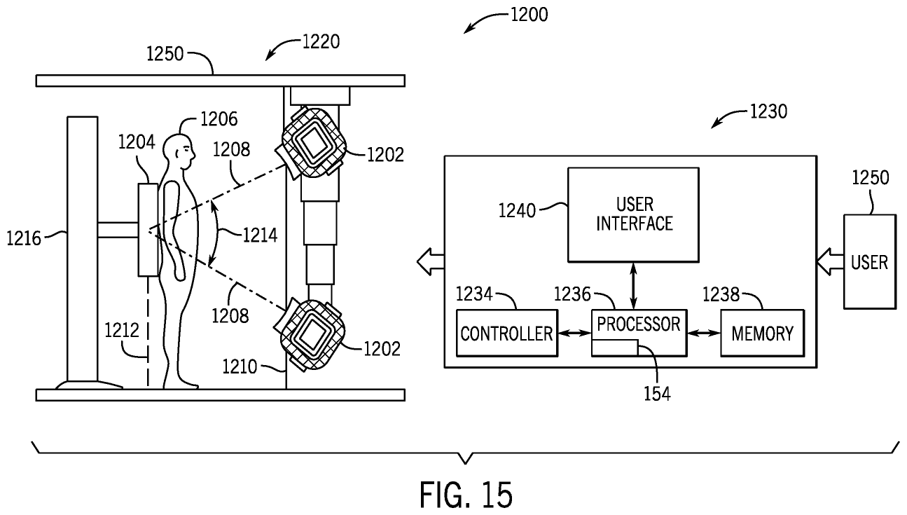

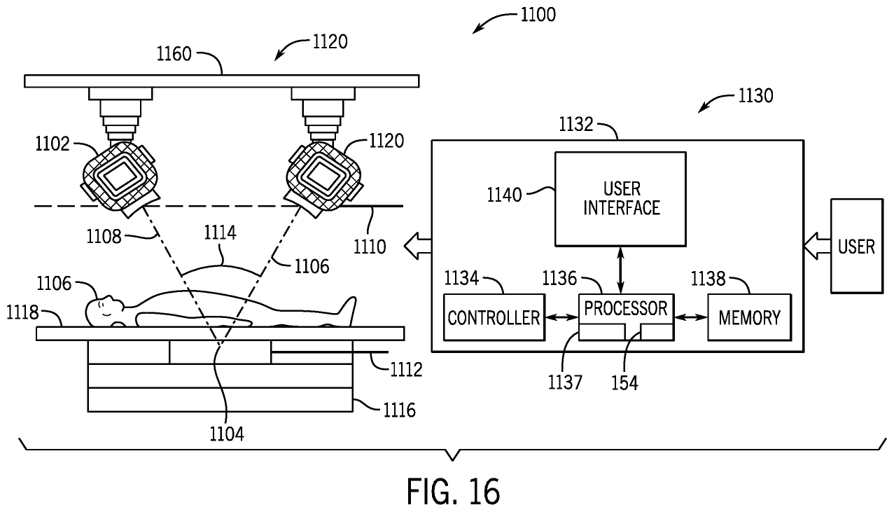

In addition to the mammography imaging device or system 100, the pseudo parallel geometry reconstruction system and method 1301 (FIGS. 9 and 10) provided via the processing unit 150/AI 152/CNN 154 (FIG. 4) in the manner to be described can also be implemented on a digital X-ray radiographic tomosynthesis system 1100,1200, as illustrated in the exemplary embodiment of FIGS. 15 and 16. FIG. 16 illustrates a table acquisition configuration having an X-ray source 1102 attached to a structure 1160 and an X-ray detector 1104 positioned within a table 1116 (functioning similar to detector 145 of FIGS. 4 and 5) under a table top 1118, while FIG. 15 illustrates a wallstand configuration having an X-ray source 1202 attached to a structure 1260 and an X-ray detector 1204 attached to a wallstand 1216. The digital X-ray radiographic tomosynthesis radiography system 1100, 1200 includes an X-ray source 1102, 1202, which subject a patient under examination 1106, 1206 to radiation in the form of an X-ray beam 1108, 1208. The X-ray beam 1108, 1208 is emitted by the X-ray source 1102, 1202 and impinges on the patient 1106, 1206 under examination. A portion of radiation from the X-ray beam 1108, 1208 passes through or around the patient and impacts the detector 1104, 1204.

In an exemplary embodiment, the X-ray source 100, 1102, 1202 may be an X-ray tube, and the object or patient under examination 132, 1106, 1206 may be a human patient, an animal patient, a test phantom, and/or other inanimate object under examination. The patient under examination 1106, 1206 is placed between the X-ray source 1102, 1202 and the detector 1104, 1204. During tomosynthesis acquisition, the X-ray source 1102, 1202 travels along the plane 1110, 1210 illustrated in FIGS. 16 and 15, and rotates in synchrony such that the X-ray beam 1108, 1208 is always pointed at the detector 1104, 1204 during the acquisition. As mentioned above, the X-ray source 1102, 1202 is typically moved along the single plane 1110, 1210 parallel to the plane 1112, 1212 of the detector 1104, 1204, although it may be moved outside of a single plane, which is substantially parallel to the detector 1104, 1204. The detector 1104, 1204 is maintained at a stationary position as radiographs are acquired. A plurality of discrete projection radiographs of the patient 1106, 1206 are acquired by the detector 1104, 1204 at discrete locations along the path 1110, 1112 of the X-ray source 1102, 1202. After acquiring projection image data from the projection radiographs, application software may be to reconstruct slice images.

The digital X-ray radiographic tomosynthesis imaging process includes a series of low dose exposures during a single sweep of the X-ray source 1102, 1202 moving within a limited angular range 1114, 1214 (sweep angle) by arc rotation and/or linear translation of the X-ray source 1102, 1202 and focused toward the stationary detector 1104, 1204. The X-ray source 1102, 1202 delivers multiple exposures during the single sweep from multiple projection angles. The sweep angle 1114, 1214 is the angle from the first projection exposure to the final projection exposure. The sweep angle 1114, 1214 is typically within a range from 20 to 60 degrees.

In an exemplary embodiment, the detector 1104, 1204 may comprise a plurality of detector elements, generally corresponding to pixels, which sense the intensity of X-rays that pass through and around patients and produce electrical signals that represent the intensity of the incident X-ray beam at each detector element. These electrical signals are acquired and processed to reconstruct a 3D volumetric image of the patient's anatomy. Depending upon the X-ray attenuation and absorption of intervening structures, the intensity of the X-rays impacting each detector element will vary.

FIGS. 15 and 16 further schematically illustrate a computer workstation 1130, 1230 coupled to a digital tomosynthesis imaging system 1120, 1220 of the digital X-ray radiographic tomosynthesis system 1100, 1200 providing a user interface 1140, 1240 for selecting at least one reconstruction, dose, and/or acquisition parameter for the digital X-ray radiographic tomosynthesis acquisition as described herein.

The digital tomosynthesis imaging system 1120, 1220 may be used for acquiring and processing projection image data and reconstructing a volumetric image or three-dimensional (3D) image representative of an imaged patient. The digital tomosynthesis imaging system 1120, 1220 is designed to acquire projection image data and to process the image data for viewing and analysis.

The computer workstation 1130, 1230 includes at least one image system/computer 1132, 1232 with a controller 1134, 1234, a processor 1136, 1236, memory 1138, 1238, and a user interface 1140, 1240. The processor 1136, 1236 may be coupled to the controller 1134, 1234, the memory 1138, 1238, and the user interface 1140, 1240. A user interacts with the computer workstation 1130, 1230 for controlling operation of the digital X-ray radiographic tomosynthesis system 1100, 1200. In an exemplary embodiment, the memory 1138, 1238 may be in the form of memory devices, memory boards, data storage devices, or any other storage devices known in the art.

The digital tomosynthesis imaging system 1120, 1220 is controlled by the controller 1134, 1234, which may furnish both power and control signals for digital tomosynthesis examination sequences, including positioning of the X-ray source relative to the patient and the detector. The controller 1134, 1234 may command acquisition of signals generated in the detector. The controller 1134, 1234 may also execute various signal processing and filtering functions, such as for initial adjustment of dynamic ranges, interleaving of digital image data, and so forth. In general, the controller 1134, 1234 commands operation of the digital tomosynthesis imaging system 1120, 1220 to execute examination protocols and to process acquired data. In an exemplary embodiment, the controller 1134, 1234 receives instructions from the computer 1132, 1232. In an exemplary embodiment, the controller 1134, 1234 may be part of the digital tomosynthesis imaging system 1120, 1220, instead of the computer workstation 1130, 1230.

In an exemplary embodiment, the computer 1132, 1232 includes or is coupled to the user interface 1140, 1240 for interaction by the user for selecting and/or changing clinically relevant parameters, such as dose, slice placement (reconstruction settings), and acquisition parameters. In an exemplary embodiment, operation of the digital X-ray radiographic tomosynthesis system 1100, 1200 is implemented through the use of software programs or algorithms downloaded on or integrated within the computer 1132, 1232.

In an exemplary embodiment, the user interface 1140, 1240 is a visual interface that may be configured to include a plurality of pre-defined tools, which will allow a user to view, select and edit reconstruction parameters (settings); view and select dose parameters; and view, select and edit tomosynthesis acquisition parameters. The plurality of pre-defined tools may include a tomosynthesis preference edit tool, a “Scout” acquisition edit tool, a tomosynthesis acquisition edit tool, and a plurality of slice image processing edit tools. The user interface 1140, 1240 also allows the user to view the reconstructed images.

In an exemplary embodiment, the user interface 1140, 1240 may include at least one input device for inputting and/or selecting information on the plurality of pre-defined tools displayed on the display of the user interface 1140, 1240. In an exemplary embodiment, the at least one input device may be in the form of a touch screen display, a mouse, a keyboard, at least one push button, or any other input device known in the art.

The processor 1136, 1236 receives the projection data from the detector 1104, 1204 and performs one or more image analyses, including that of a computer aided detection (CAD) system, among others, through one or more image processing operations. The processing unit/processor 1136, 1236 exemplarily operates to create a 3D volume using the projection data/projections and analyzes slices of the 3D volume to determine the location of lesions and other masses present within the 3D volume, as well as to store the 3D volume within a mass storage device 1138, 1238, where the mass storage device 1138, 1238 may include, as non-limiting examples, a hard disk drive, a floppy disk drive, a compact disk-read/write (CD-R/W) drive, a Digital Versatile Disc (DVD) drive, a flash drive, and/or a solid-state storage device. As used herein, the term computer is not limited to just those integrated circuits referred to in the art as a computer, but broadly refers to a processor, a microcontroller, a microcomputer, a programmable logic controller, an application specific integrated circuit, and any other programmable circuit, and these terms are used interchangeably herein. It will be recognized that any one or more of the processors and/or controllers as described herein may be performed by, or in conjunction with the processing unit/processor 1136, 1236, for example through the execution of computer readable code stored upon a computer readable medium accessible and executable by the processing unit/processor 1136, 1236. For example, the computer/processing unit/processor 1136, 1236 may include a processor configured to execute machine readable instructions stored in the mass storage device 1138, 1238, which can be non-transitory memory. Processor unit/processor/computer 1136, 1236 may be single core or multi-core, and the programs executed thereon may be configured for parallel or distributed processing. In some embodiments, the processing unit 1136, 1236 may optionally include individual components that are distributed throughout two or more devices, which may be remotely located and/or configured for coordinated processing. In some embodiments, one or more aspects of the processing unit 1136, 1236 may be virtualized and executed by remotely-accessible networked computing devices configured in a cloud computing configuration. According to other embodiments, the processing unit/computer 1136, 1236 may include other electronic components capable of carrying out processing functions, such as a digital signal processor, a field-programmable gate array (FPGA), or a graphic board. According to other embodiments, the processing unit/computer 36 may include multiple electronic components capable of carrying out processing functions. For example, the processing unit/computer 1136, 1236 may include two or more electronic components selected from a list of electronic components including: a central processor, a digital signal processor, a field-programmable gate array, and a graphic board. In still further embodiments the processing unit/computer 1136, 1236 may be configured as a graphical processing unit (GPU) including parallel computing architecture and parallel processing capabilities.

Referring again to FIG. 4, in the process of the reconstruction of the 3D planes/slices and/or volume 171, the processing unit 150 includes an artificial intelligence or deep leaning network(s) 152, e.g., a CNN 154, that has been trained using a pseudo parallel geometric reconstruction system and process 1301 (FIGS. 9 and 10) to the projection images/projection set 101-109 in the formation of reconstructed 3D planes/slices and/or volume 171, particularly with regard to reconstruction of 3D XZ planes/slices 171. In one exemplary embodiment, the processing unit 150 can access instructions stored within the memory 160 for the operation of the AI 152/CNN 154 to perform the pseudo parallel geometry reconstruction process or method 1301 (FIGS. 9 and 10).

When training and/or preparing the AI 152/CNN 154 for instantiation on the system 100 for providing the pseudo parallel geometric system and process 1301 in reconstruction of a 3D plane/slice and/or volume 171, in one exemplary embodiment the most straightforward way to train the deep learning network 152, e.g., CNN 154, in a reconstruction pipeline, i.e., for the correction and reconstruction of a 3D volume 171 from a plurality of 2D images 101-109, is by utilizing a fully supervised training model. However, the embodiments of the present disclosure are not limited to a fully supervised training model(s), as the training can also be performed using a partially or semi-supervised training model or an unsupervised training model, and we describe the fully supervised training model only as an exemplary embodiment of a suitable training model for the deep learning network. In a fully supervised training setting for a deep learning network employed for 3D volume reconstruction of DBT projection images the training can be based on the use of simulated acquisitions of numerical objects, e.g., a digital phantom, provided as the input(s) to the network. The numerical objects can be simulated breast anatomies, for instance anatomies the same as or similar to those utilized in the Virtual Imaging Clinical Trial for Regulatory Evaluation (the VICTRE trial) which used computer-simulated imaging of 2,986 in silico patients to compare digital mammography and digital breast tomosynthesis, or other breast(s)/breast anatomies imaged with other modalities like MRI, or breast CT, or a combination of some or all of these images. The simulated acquisitions employed as inputs during training of the deep learning network (e.g., CNN) can resort to digital twin techniques that model the x-ray imaging systems compared in the VICTRE trial. Using such objects, the training database construction can simulate an acquisition of a number of DBT projection images at given source positions. A pair for supervised learning can be formed by the set of simulated projections as inputs, and the original numerical object converted or corrected into a virtual object in the pseudo parallel geometry as the truth for comparison with the output from the pseudo parallel geometry correction and reconstruction AI or deep learning network 152/CNN 154. By repeating this process on a database containing a number of different of numerical objects, such as synthetic numerical object phantoms derived from one or more of CT or MRI scans of organs of interest, breast CT or breast MRI scans and chest CT or chest MRI scans. one creates a database of 2D image pairs for inputs and associated truths that can be used to train a reconstruction algorithm, e.g., AI 152/CNN 154, in a supervised manner for operating the pseudo parallel geometric correction and reconstruction system and process 1301 as a part of the reconstruction of the 3D place/slice and/or volume 171 employed by the system 100. It is important to note here that the ground truth object must be converted or corrected to a virtual object in the pseudo parallel geometry as explained in this description so that its geometry matches the one of the pseudo parallel geometry correction and/or reconstruction AI or deep learning network 152/CNN 154.

Another way to define the training database for training the AI 152/CNN 154 for use in the pseudo parallel geometric correction and reconstruction system and process 1301 is to use a volume obtained by reconstructing another simulated DBT projection set that simulates a desired acquisition sequence (more views, more dose, wider angular range etc.) as the truth associated with the simulated projections employed to reconstruct the volume. Again, in such a training system or process the volume that defines the truth must be reconstructed in the pseudo parallel geometry or corrected to match this geometry.

With any of the aforementioned training pairs or any other suitable training pairs or methods, the processing unit 150/AI 152/CNN 154 forming and/or employing the pseudo parallel geometric correction and/or reconstruction system and method 1301 disclosed herein enables great simplification of the training and evaluation of the deep learning networks, e.g., CNNs, utilized for the correction and reconstruction of the 3D plane/slice and/or volume 171. More specifically, the pseudo parallel geometric correction and reconstruction system and process 1301 performed by the processing unit 150/AI 152/CNN 154 enables the downstream use of 2D or 2.5D trained networks (CNNs) for a simplified reconstruction of 3D volumes 171 from 2D projection images 101-109 and/or artifact removal within the XZ and XY planes of the reconstructed 3D slice and/or volume(s) 171. In particular, the pseudo parallel geometric correction system and method 1301 disclosed herein enables the processing unit 150/AI 152/CNN 154 to geometrically correct a reconstructed virtual object and/or volume reconstructed from the projections 101-109 and any artefacts therein as defined by the system 100 prior to use as an input to a separate volume reconstruction AI/deep learning network, e.g., CNN, for reconstruction of the corrected 3D slice and/or volume 171. The pseudo parallel geometric correction system and method 1301 thereby eliminates the need for correction of the angular orientation of the artefacts relative to the XZ or XY planes by a 3D reconstruction CNN, consequently eliminating the requirement for simulation of these corrections in the training and the test coverage of a reconstruction deep learning algorithm, e.g., a 2D, 2.5D or 3D CNN network. Thus, the pseudo parallel geometric system and method 1301 disclosed herein enables the straightforward use of 2D or 2.5D reconstruction CNNs to reconstruct a corrected 3D slice and/or volume 171 in the XZ and/or XY planes. In particular, with the simplification of the information provided by the pseudo parallel geometric correction system and process 1301 as the input(s) to the 2D or 2.5D reconstruction CNNs 1320, i.e., the projections 101-109 and/or virtual object, slice/plane 1302 or volume 1310, a 2D/2.5D reconstruction CNN 1320 may be trained and employed to construct a corrected 3D slice and/or volume 171 along the XZ axis using a 2D image training database. As a 2D image database/training dataset is easier to collect, this can also alleviate the complexity of the training database construction task. Alternatively, or in conjunction or combination with the above, the processing unit 150/AI 152/CNN 154 can be trained from a 2D image database associated to or obtained from 1D projections.

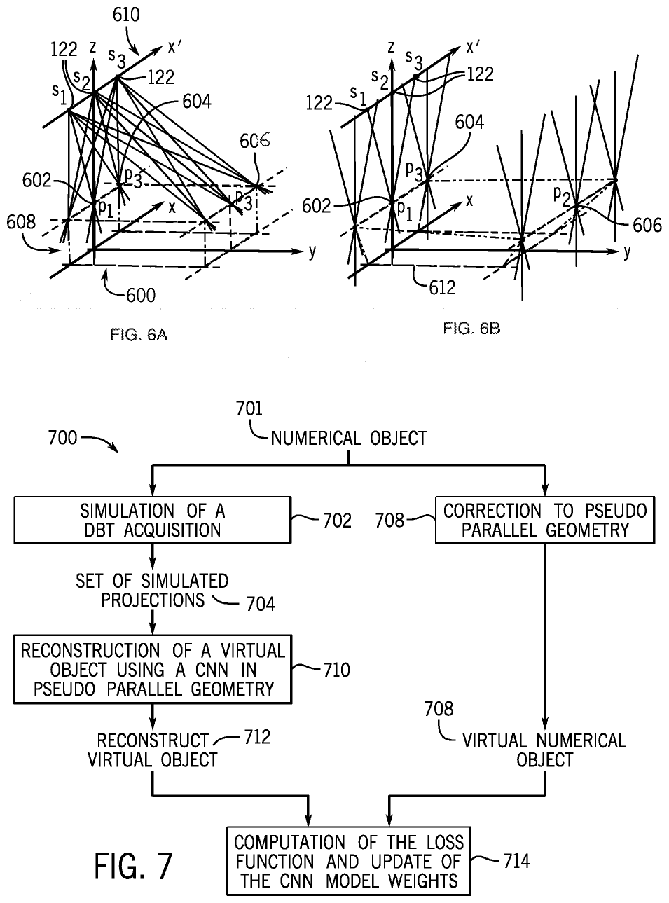

With reference now to FIGS. 6A-6B, a representation of the operation of the pseudo parallel geometric correction and/or reconstruction to be employed by the AI 152/CNN 154 is illustrated, an operation which is not discussed at length herein but is disclosed in Nett, Brian E., Shuai Leng, and Guang-Hong Chen. “Planar tomosynthesis reconstruction in a parallel-beam framework via virtual object reconstruction.” Medical Imaging 2007: Physics of Medical Imaging. Vol. 6510. SPIE, 2007 (Nett), incorporated by reference herein in its entirety for all purposes. In FIG. 6A, which is similar to FIG. 3, a numerical or simulated parallelepipedal object 600 is shown including a number of artefacts 602,604,606 therein. When simulated projection images of the numerical object 600 are obtained at points s₁, s₂, and s₃ for the radiation source 140, the artefacts 602,604,606 are disposed or oriented at various angles relative to the XZ plane 608 defined by the coordinate system 610 for the simulated imaging procedure from which the projection images of the numerical object 600 are obtained, such as would be the situation for a standard geometry and reconstruction of the numerical object 600.

Referring now to FIG. 6B, in the performance of the pseudo parallel correction of the orientation of the artefacts 602,604,606 in the numerical object 600, the object 600 is reconstructed is a virtual object 612 whose overall shape changed from parallelepipedal to trapezoidal as a result of the distortion in the shape of the virtual object 612 resulting from a magnification based on the height of the reconstructed XZ plane. More specifically, a result of the pseudo parallel reconstruction performed on the simulated object 600, the reconstructed artefacts 602,604,606 are oriented with respect to a selected reference angle, such as a selected angle of the source 122 relative to the artefact 602, to be nearly aligned on the same direction everywhere in the volume for the virtual object 612, and are contained in XZ planes, similar to the source angle/projection image for artefact 602. With the change in orientation of the artefacts 604 and 606 to be completely contained within the selected planes, e.g., in the XZ planes in FIG. 6B, consequently the geometry of the virtual object 612 differs from the geometry of the numerical object 600.

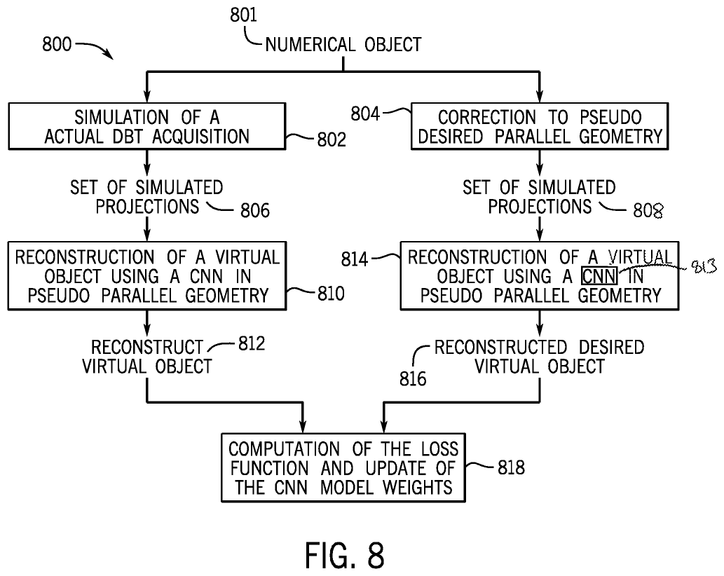

Referring now to FIGS. 7 and 8, some exemplary embodiments of methods of training the AI 152/CNN 154 to perform the pseudo parallel geometric correction prior to instantiation on the imaging system 100 are illustrated. In the method 700 shown in FIG. 7, initially a numerical object 701, which can be stored information regarding an actual object, a phantom object or a simulated object, including synthetic numerical object phantoms derived from CT or MRI scans of organs of interest, breast CT or breast MRI scans and chest CT or chest MRI scans, in step 702 is employed as the subject of a simulated DBT acquisition to generate a set of simulated projection images 704. The same numerical object 700 is also subjected to a pseudo parallel geometric correction in step 706 in order to produce a corrected virtual numerical object 708, with the pseudo parallel geometric construction process performed being similar to that discussed with regard to FIG. 6.

In step 710, the set of simulated projection images 704 is provided as an input to a CNN, e.g., CNN 154, which performs a pseudo parallel geometric reconstruction on the image set 704 to produce a reconstructed virtual object 712. In step 714 the reconstructed virtual object 712 is compared with the corrected virtual object 708, i.e., an ideal pseudo parallel geometrically corrected object, in order to compute the loss function and to correspondingly update the model weights for the CNN 154 for use in a subsequent performance(s) of the method 700 to further train the operation of the CNN 154 until the loss function reaches the desired parameters. In this embodiment the corrected virtual object 708 functions as the ground truth for the comparison with the reconstructed virtual object 712.

In another exemplary embodiment for the training of the AI 152/CNN 154, in the method 800 shown in FIG. 8 the numerical object 801, e.g., a physical object or a simulated object, is employed as the subject for each of a simulated actual DBT acquisition in step 802 and a simulated desired DBT acquisition in step 804 to produce a pair of simulated projection sets 806,808, with the desired DBT acquisition including an optimal number if simulated projections and the omission of one or more non-optimal parameters, such as scatter, among others.

The projection set 806 from the simulated actual acquisition is input into the CNN 154 in order to undergo a reconstruction of the projections using a pseudo parallel geometric reconstruction in step 810 to produce a reconstructed actual virtual object 812 as an output from the CNN 154. Additionally, the projection set 808 produced by the simulated desired or optimal acquisition is input into a separate reconstruction algorithm, network or CNN 813 in order to undergo a reconstruction of the projections 808 using a pseudo parallel geometric reconstruction in step 814 to produce a reconstructed desired virtual object 816 as an output from the CNN 813. In an alternative embodiment, the desired virtual object is reconstructed using the pseudo parallel geometric reconstruction using a suitable algorithm that is not an artificial intelligence or CNN.

Subsequently, in step 818 the reconstructed actual virtual object 812 is compared with the reconstructed desired virtual object 816 for computation of the loss function to update the model weights of the CNN 154 for use in a subsequent performance(s) of the method 700 to further train the operation of the CNN 154 until the loss function reaches the desired parameters. In this embodiment the reconstructed desired virtual object 816 functions as the ground truth for the comparison with the actual virtual object 812.

In certain examples of a reconstruction system and method 1300 shown in FIG. 9 employed by the system 100 including the trained AI 152/CNN 154 for reconstructing and correcting for artefacts in the 3D volume 171 from the 2D/DBT projection images 101-109 employing a pseudo parallel geometric correction and reconstruction process and/or method 1301, initially in step 1303 the projection images 101-109 are obtained by the system 100 in the manner described previously. These projection images 101-109 are provided as an input to the processing unit 150/AI 152/CNN 154 which performs the pseudo parallel geometric reconstruction and correction process and/or method 1301 thereon.

In a first embodiment, in the first step 1350 of the process 1301, the processing unit 150 reconstructs a 3D virtual object, such as one or more virtual slices (XY) or planes (XZ, XY, or YZ), slabs, 1302 and/or a virtual volume 1310, from the projection set 101-109 employing a pseudo parallel geometry reconstruction, as described with regard to FIG. 6. In this process the artefacts are reoriented to a reference artefact orientation as shown in FIG. 6. In the implementation of this pseudo parallel geometry correction in step 1350, each of the planes 1302 and/or the volume 1310 comprising the virtual object(s) are transformed to align geometrically with the reference angle for the zero or central projection 105, as shown in FIG. 4, such that the virtual object, e.g., each plane 1302 and/or the volume 1310 and the artefacts contained therein, is oriented generally perpendicularly to the detector 140. In one exemplary embodiment, the planes 1302 and/or object/volume 1310 that is reconstructed in the pseudo parallel geometric reconstruction method or system 1301 is a 3D virtual object reconstructed from 2D images of an actual object, such as DBT projection images 101-109 of a breast. This family of pseudo parallel reconstruction methods has been proposed for planar tomosynthesis as described in Nett, but has not previously been applied in a process for the reconstruction of a 3D volume 171 oriented in the manner of the present disclosure, e.g., in the XZ and/or XY axis or plane 1302 using a CNN 154, such as a 2D or 2.5D CNN.

In step 1305, each of the pseudo parallel reconstructed planes 1302 and/or volume 1310 are fed into the trained CNN 154 dedicated to the correction of the artefacts. With this altered geometric orientation for the virtual object, e.g., each plane 1302 and/or the object volume 1310 and the artefacts therein, it is not necessary for the subsequent reconstruction deep learning network or CNN 154 to correct for the angular displacement of any artefact located within the planes 1302/volume 1310 during correction of the artefacts in reconstruction of the corrected 3D slice or volume 171, as each artefact oriented is parallel to the reference angle, thereby greatly simplifying the processing and removal of the artefacts within the planes 1302 in the reconstruction of the volume 171 by the trained reconstruction AI 152/CNN 154. In an alternative embodiment, instead of being performed in the processing unit 150, the first step 1350 of initial reconstruction in pseudo parallel geometry can be implemented as a portion of the AI 152 or within layers in the CNN 154.

In another exemplary embodiment, with reference now to FIG. 10 which discloses an alternative for the method 1300 of FIG. 9, as a result of the geometric re-alignment of the planes 1302 to align with the refence angle/zero projection by the pseudo parallel geometric correction system and method 1301 as implemented by the processing unit 150, the artefacts are mostly planar in XZ planes. As such, the subsequent trained CNN 154 can operate simply as a 2D or a 2.5D network in the XZ planes. The training and operation of the CNN 154 employed by the system 100 for correction of the artefacts in the 3D volume 171 in step 1305 from the pseudo parallel geometry reconstructed projections 101-109, virtual slice/plane 1302 and/or virtual object/volume 1310 is thus streamlined and/or simplified by reconstructing the output 3D volume 171 using a the re-aligned XZ axis planes 1302 and/or volume 1310.

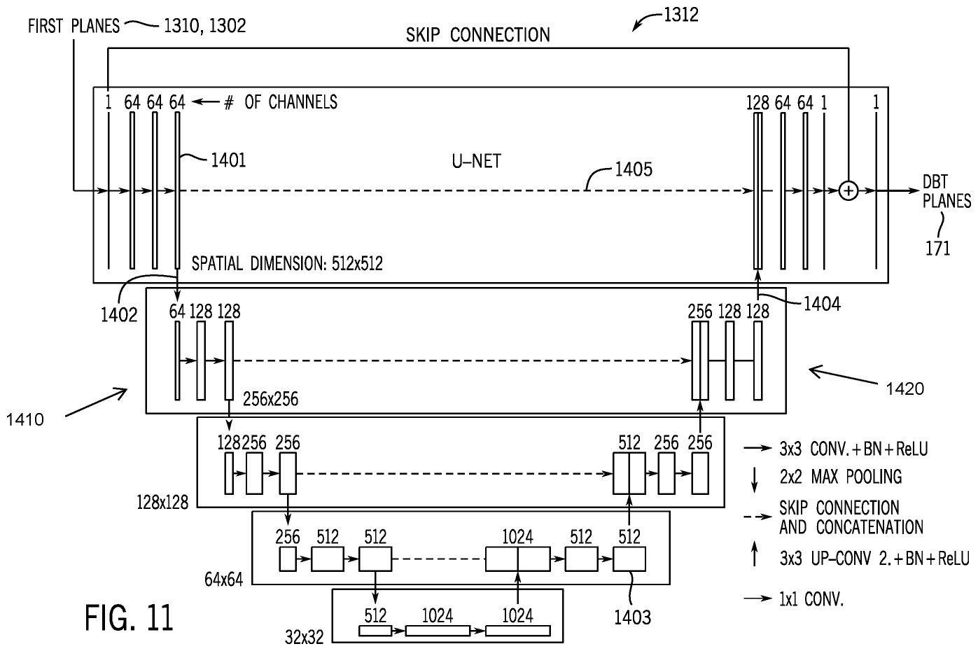

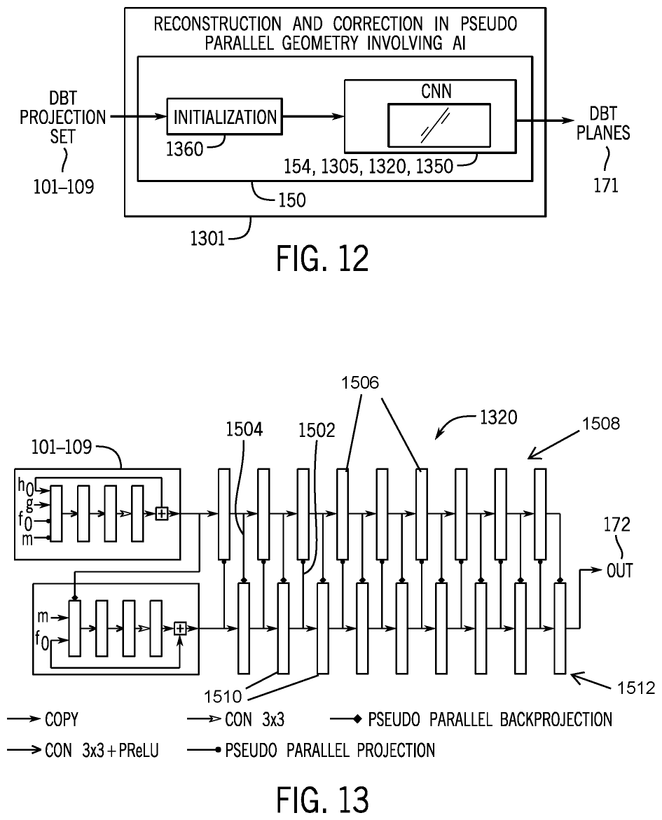

With regard now to FIGS. 9-11, regarding exemplary implementations of the process of the present pseudo parallel geometric reconstruction and correction method 1301, initially the 2D DBT projection images/tomosynthesis dataset 101-109 of the subject/organ are employed by the processing unit 150 to reconstruct the organ, e.g., the breast, as a virtual object, 3D volume 1310, planes or slices 1302 with regard to the XZ axis in alignment with a zero projection 105 (FIG. 4) or reference angle, e.g., a selected angle of 0° perpendicular to the detector 145, or the angle of the central projection of the tomosynthesis dataset or another suitable angle, angle relative to the chest wall of the patient. Inside the reconstruction algorithm employed by the processing unit 150 in step 1350 or alternatively as employed as part of the deep learning network 152/CNN 154 to perform the pseudo parallel geometric reconstruction and correction process 1301, two operators are necessary: the back-projection that maps a projection image 101-109 to the volume 1310, and a forward projection that maps the volume 1310 to a projection image 101-109, as shown in the exemplary embodiments for the CNN 154 illustrated in FIGS. 11 and 12. The forward projection operator is used in networks that implement unrolled or primal-dual methods. It can also be used in iterative reconstructions steps that are performed prior to, as in step 1350, or after the correction provided by the trained AI 152/CNN 154.

FIG. 11 illustrates a particular implementation of an exemplary CNN 154 employed within the method 1300 of FIG. 9 or 10 illustrated as being formed with a UNet architecture 1312, though other suitable network architectures can also be employed. In this embodiment the UNet network 1312 is taking in input a first a virtual object volume 1310 reconstructed in the pseudo parallel geometry and applying artefact correction to it. The Unet architecture/network 1312 involves typically convolutions and non-linearities 1401 at constant spatial resolution followed by max pooling operators 1402 in an analysis path 1410 that are repeated in a series of levels. On the synthesis part 1420 the data undergoes convolution and non-linearities 1403 followed by up convolution operators 1404. Analysis and synthesis blocks are linked by skip connections 1405, to enable the network 1312 to output the corrected DBT planes/3D volume 171.

Referring now to FIGS. 12 and 13, another particular example of the method 1300 and the trained CNN 154 employed therein is illustrated in which the CNN 154 is formed with a learned primal dual reconstruction algorithm 1320 in which the forward projection/projection operator and backprojection operator are replaced by pseudo parallel geometry forward projection 1502 and backprojection 1504 operators. In this embodiment the network 154, 1320 is typically fed with the projections 101-109 (denoted g in the figure), initialized primal and dual vectors (h0 and f0 in the figure) that are initialized in a step 1360, and in some embodiments of system information, including but not limited to the breast thickness or a 3D breast mask, which is denoted m in the FIG. 13. The dual blocks 1506 in the upper row 1508 operate in the projection domain. They are coupled to primal blocks 1510 in the bottom row 1512. They are interconnected by forward projection operators 1502 and back projection operators 1504. In our invention these operators 1502, 1504 are implemented in the pseudo parallel geometry. With this pseudo parallel geometry implementation directly within the network 154,1320, any artefacts are mostly aligned in the XZ planes and are nearly invariant in orientation through the reconstruction of the planes 1302 and/or volume 1310. This simplifies the training, testing of the CNN 154,1320 and enables it to operate as 2D or 2.5D network in the correction of the artefacts disposed within the XZ planes of the reconstructed planes 1302 and/or volume 1310.

In the operation of the learned primal dual reconstruction algorithm 1320 to reconstruct the planes 1302 and/or object/3D volume 1310 in a pseudo parallel geometry from the projections 101-109, after initialization, to perform the back-projection, a first pseudo parallel geometry operator 1504 reconstructs the planes 1302/virtual object 1310 from the projection images/projection dataset 101-109 back projected in parallel geometry to the reference angle defined by the zero projection 105 relative to the detector 145, such that the reconstructed plane 1302/virtual object 1310 is matching the central or zero projection 105 when projected with a parallel projection operator. One exemplary way to achieve this is to combine a standard cone-beam back-projection and a magnification that is dependent on the reconstructed height of the plane, as described previously with regard to FIG. 6 and referenced in Nett.

Further, during the forward projection performed by the CNN 154,1320, a second pseudo parallel geometry operator 1502 reprojects (or forward projects) the virtual object 1310 along the different projection angles of each initial projection 101-109 by combining a demagnification that is dependent on the heights of the forward projected planes of the virtual object 1310 and a standard cone-beam forward projection.

The same pseudo parallel geometric correction and reconstruction system and method 1301 can be employed by the processing unit 150, and trained AI 152/CNN 154, and combinations thereof, for any other reference angle within the range of the positions of the source 140 relative to the detector 145. In this manner, the geometric transformation of the voxels of each plane or slice 1302 and/or of the virtual object volume 1310 to be parallel to the reference angle, i.e., to the detector 145, significantly simplifies the structure and/or computational requirements on the reconstruction and/or correction deep learning network, or CNN 154,1312,1320 used to reconstruct and/or correct form the viewable 3D volume 171 using the virtual object volume 1310 as input. Though the use of the system and method 1301, the artefacts present within the planes 1302/virtual object volume 1310 are transformed from artefacts that are highly translation variant and oriented along planes that are angled with respect to the coordinates axes of the reconstruction into artefacts 602,604,606 that are substantially translation invariant and oriented along planes that are aligned with the coordinates axes of the reconstruction, as depicted in FIG. 6. Consequently, with this geometric alignment of the planes 1302/volume 1310 with regard to the reference angle, e.g., perpendicular to the detector 145, the speed and/or performance of the training, testing and performance of the deep learning network 152, e.g., CNN 154,1312,1320, employed on the imaging system 100 is significantly improved over prior art deep learning networks.

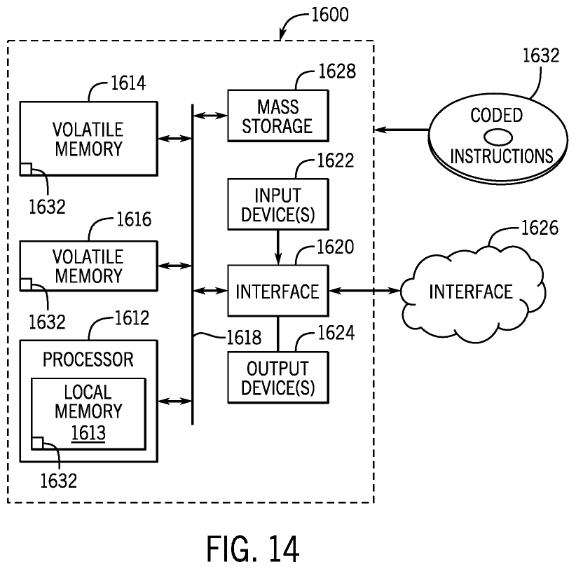

In an illustrated exemplary embodiment, after being trained according to one of the aforementioned training processes, the algorithm/AI 152/CNN 154 employing the pseudo parallel geometric correction system and method 1301 can be instantiated on the imaging system 100 in a variety of suitable manners. For example, the algorithm/AI 152/CNN 154 can be employed as machine readable instructions comprising a program for execution by a processor such as the processor 1612 shown in the example processor platform 1600 discussed below in connection with FIG. 14 and forming an exemplary embodiment of the processing unit 150 for the system 100. The program may be embodied in software stored on a tangible computer readable storage medium such as a CD-ROM, a floppy disk, a hard drive, a digital versatile disk (DVD), a Blu-ray disk, or a memory associated with the processor 1612, but the entire program and/or parts thereof could alternatively be executed by a device other than the processor 1612 and/or embodied in firmware or dedicated hardware. Further, although the example program is described with reference to FIGS. 9-13, many other methods of implementing the example method 1301 may alternatively be used, changed, eliminated, or combined.

FIG. 14 is a block diagram of an example processor platform 1600 capable of implementing the example system and method 1301 of FIGS. 9-13. The processor platform 1600 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1600 of the illustrated example includes a processor 1612. The processor 1612 of the illustrated example is hardware. For example, the processor 1612 can be implemented by one or more integrated circuits, logic circuits, microprocessors or controllers from any desired family or manufacturer.

The processor 1612 of the illustrated example includes a local memory 1613 (e.g., a cache). The processor 1612 of the illustrated example is in communication with a main memory including a volatile memory 1614 and a non-volatile memory 1616 via a bus 1618. The volatile memory 1614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1616 may be implemented by flash memory and/or any other desired type of memory device. Access to the main memory 1614, 1616 is controlled by a memory controller.

The processor platform 1600 of the illustrated example also includes an interface circuit 1620. The interface circuit 1620 may be implemented by any type of interface standard, such as an Ethernet interface, a universal serial bus (USB), and/or a PCI express interface.

In the illustrated example, one or more input devices 1622 are connected to the interface circuit 1620. The input device(s) 1622 permit(s) a user to enter data and commands into the processor 1612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1624 are also connected to the interface circuit 1620 of the illustrated example. The output devices 1624 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1620 of the illustrated example, thus, typically includes a graphics driver card, a graphics driver chip or a graphics driver processor.

The interface circuit 1620 of the illustrated example also includes a communication device such as a transmitter, a receiver, a transceiver, a modem and/or network interface card to facilitate exchange of data with external machines (e.g., computing devices of any kind) via a network 1626 (e.g., an Ethernet connection, a digital subscriber line (DSL), a telephone line, coaxial cable, a cellular telephone system, etc.).

The processor platform 1600 of the illustrated example also includes one or more mass storage devices 1628 for storing software and/or data. Examples of such mass storage devices 1628 include floppy disk drives, hard drive disks, compact disk drives, Blu-ray disk drives, RAID systems, and digital versatile disk (DVD) drives, which can be local, e.g., formed as an integrated part of the platform 1600, or remote, operably connected to the processor platform 1600 via the network 1626, for example.

The coded instructions 1632 of FIG. 14 may be stored in the mass storage device 1628, in the volatile memory 1614, in the non-volatile memory 1616, and/or on a removable tangible computer readable storage medium such as a CD or DVD.

As mentioned above, the example processes 1301 of FIGS. 9-13 and CNN 154,1312,1320 employed therein may be implemented using coded instructions 1632 (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. As used herein, when the phrase “at least” is used as the transition term in a preamble of a claim, it is open-ended in the same manner as the term “comprising” is open ended.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Technical effects of the disclosed subject matter include providing systems and methods that utilize AI (e.g., deep learning networks) to provide enhanced artefact reduction in reconstructed volumes where the AI is trained to employ a pseudo parallel reconstruction system and process based off of a selected reference projection that greatly simplifies the computational requirements, efficiency, training and testing steps of the AI152/CNN 154,1312,1320 in the reconstruction process.

This written description uses examples to disclose the subject matter, including the best mode, and also to enable any person skilled in the art to practice the subject matter, including making and using any devices or systems and performing any incorporated methods. The patentable scope of the disclosed subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A method for correcting artefacts within a three-dimensional (3D) volume reconstructed from a plurality of two-dimensional (2D) projection images of an object, the method comprising the steps of:
a. providing an imaging system comprising:
i. a radiation source;
ii. a detector positionable to receive radiation emitted from the radiation source and passing through an object positioned between the source and the detector;
iii. a display for presenting information to a user;
iv. a processing unit connected to the display and operable to control the operation of the radiation source and detector to generate a plurality of 2D projection images of the object; and
v. a memory operably connected to the processing unit and storing processor-executable code for a reconstruction algorithm that when executed by the processing unit is operable to reconstruct a three-dimensional (3D) volume of the organ from the plurality of 2D projection images;
b. obtaining the plurality of 2D projection images;
c. selecting a zero angle from a range of angles over which the plurality of 2D projection images are obtained;
d. reconstructing the 3D volume from the plurality of 2D projection images, the 3D volume defined in a pseudo parallel geometry based on the zero angle from the plurality of 2D projection images.

2. The method of claim 1, wherein the step of reconstructing the 3D volume comprises:
a. reconstructing a 3D virtual object defined in the pseudo parallel geometry based on the zero angle from the plurality of 2D projection images; and
b. correcting the 3D virtual object to form the 3D volume.

3. The method of claim 2, wherein the reconstruction algorithm includes a network operable to reconstruct and correct the 3D virtual object defined in the pseudo parallel geometry based on the zero angle from the plurality of 2D projection images.

4. The method of claim 3, wherein the network operable to reconstruct and correct the 3D virtual object defined in the pseudo parallel geometry based on the zero angle from the plurality of 2D projection images is selected from a 2D or 2.5D network.

5. The method of claim 4, wherein the network operable to reconstruct and correct the 3D virtual object defined in the pseudo parallel geometry based on the zero angle from the plurality of 2D projection images comprises a network that reconstructs and corrects the 3D virtual object along an XZ plane defined by the imaging system.

6. The method of claim 4, wherein the network operable to reconstruct and correct the virtual object defined in the pseudo parallel geometry based on the zero angle from the plurality of 2D projection images comprises a network that reconstructs and corrects the virtual object along an XY plane defined by the imaging system.

7. The method of claim 3, wherein the network is a convolutional neural network.

8. The method of claim 3, wherein the network embeds a back projection operator and a forward projection operator, and wherein the back projection and the forward projection operators are implemented in the pseudo parallel geometry.

9. The method of claim 8, wherein the network is a learned primal dual reconstruction network.

10. The method of claim 3, wherein the 3D virtual object is selected from a 3D slice, a 3D slab, a 3D plane, a 3D volume and combinations thereof.

11. The method of claim 1, wherein the processor-executable code for reconstruction algorithm is a 2D or 2.5D convolutional neural network.

12. The method of claim 1, wherein the reconstruction algorithm includes a network operable to reconstruct and correct a 3D virtual object defined in the pseudo parallel geometry based on the zero angle from the plurality of 2D projection images, and wherein the step of reconstructing the 3D volume comprises:
a. reconstructing the 3D virtual object defined in the pseudo parallel geometry based on the zero angle from the plurality of 2D projection images; and
b. providing the 3D virtual object as an input to the network.

13. The method of claim 11 where the network is trained in a supervised manner on a database where a ground truth has been mapped to a virtual ground truth according to the pseudo parallel geometry.

14. The method of claim 11 wherein the network is trained from a 2D image database obtained from 1D projections.

15. The method of claim 11 wherein the network is trained on a database including synthetic numerical object phantoms derived from CT or MRI scans of organs of interest, breast CT or breast MRI scans and chest CT or chest MRI scans.

16. An imaging system comprising:
a. a radiation source;
b. a detector positionable to receive radiation emitted from the radiation source and passing through an object positioned between the source and the detector;
c. a display for presenting information to a user;
d. a processing unit connected to the display and operable to control the operation of the radiation source and detector to generate a plurality of 2D projection images of the object; and
e. a memory operably connected to the processing unit and storing processor-executable code for a reconstruction algorithm that when executed by the processing unit is operable to reconstruct a three-dimensional (3D) volume of the organ from the plurality of 2D projection images;
wherein the memory includes processor-executable code for:
reconstructing the 3D volume from the plurality of 2D projection images, the 3D volume defined in a pseudo parallel geometry based on a zero angle from the plurality of 2D projection images,
wherein the step of reconstructing the 3D volume comprises:
1. reconstructing a 3D virtual object defined in the pseudo parallel geometry based on the zero angle from the plurality of 2D projection images; and
2. correcting the 3D virtual object to form the 3D volume.

17. The imaging system of claim 16, wherein the processor-executable code for the reconstruction algorithm comprises processor-executable code for a network operable to reconstruct and correct the 3D virtual object defined in the pseudo parallel geometry based on the zero angle from the plurality of 2D projection images.

18. The imaging system of claim 16, wherein the processor-executable code for the reconstruction algorithm comprises processor-executable code for a 2D or 2.5D network operable to reconstruct and correct the 3D virtual object defined in the pseudo parallel geometry based on the zero angle from the plurality of 2D projection images.

19. The imaging system of claim 16, wherein the processor-executable code for the reconstruction algorithm comprises processor-executable code for a network that reconstructs and corrects the 3D virtual object along an XZ plane defined by the imaging system.

20. The imaging system of claim 16, wherein the processor-executable code for the reconstruction algorithm comprises processor-executable code for a network that reconstructs and corrects the 3D virtual object along an XY defined by the imaging system.

21. The imaging system of claim 16, wherein the processor-executable code for reconstructing the 3D virtual object comprises processor-executable code for a network operable to reconstruct and correct the 3D virtual object defined in the pseudo parallel geometry based on the zero angle from the plurality of 2D projection images, for reconstructing the 3D virtual object defined in the pseudo parallel geometry based on the zero angle from the plurality of 2D projection images with the reconstruction algorithm; and providing the 3D virtual object as an input to the network.
